(19) United States
(12) Patent Application Publication
(10) Pub. No.: US 2005/0142248 A1
(43) Pub. Date: Jun. 30, 2005

(54) Fish-farming solid feed and process for producing same

(76) Inventors: Yoshiaki Miyota, Kawasaki-shi (JP); Makoto Saito, Kawasaki-shi (JP); Hiroshi Ishii, Kawasaki-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/511,682

(22) PCT Filed: Apr. 18, 2003
(86) PCT No.: PCT/JP03/04997

Related U.S. Application Data
(60) Provisional application No. 60/374,814, filed on Apr. 24, 2002.

(30) Foreign Application Priority Data
Apr. 18, 2002 (JP) 2002-153151

(51) Int. Cl. A01K 1/00

(52) U.S. Cl. 426/2

(57) ABSTRACT

A fish-farming solid feed containing stabilized vitamin C, wherein at least 50% by mass of stabilized vitamin C, based on the total weight thereof contained in the solid feed, is present in a surface layer portion of the solid feed, spanning from the surface to a 1 mm depth; or the content of stabilized vitamin C in a surface layer portion spanning from the surface to a 1 mm depth of the solid feed is at least 50 ppm by mass. The fish-farming solid feed can be produced by a process wherein a fish-farming feed material is kneaded and shaped into a shaped product; the shaped product is dried; and then, the dried shaped product is contacted with stabilized vitamin C having been dissolved, emulsified or dispersed in a liquid such as vegetable or animal oil, preferably fish oil.

### CROSS-REFERENCE TO RELATED APPLICATION

This application is an application filed under 35 U.S.C. § 111(a) claiming benefit pursuant to 35 U.S.C. § 119(e)(1) of the filing date of Provisional Application 60/374,814 filed Apr. 24, 2002, pursuant to 35 U.S.C. § 111(b).

### TECHNICAL FIELD

This invention relates to a fish-farming solid feed containing an ascorbic acid derivative which exhibits an ascorbic acid activity and is stable, especially stable with time in the feed; and a process for producing the fish-farming solid feed.

### BACKGROUND ART

It is well known that deficiency or shortage of L-ascorbic acid in cultured fishes causes scurvy which occasionally causes death. For example, a plurality of abnormal fishes signed with scoliosis developed in many rainbow trout fishfarms in 1962. It was proved that these symptoms are caused by deficiency of L-ascorbic acid (Japan Fisheries Society, vol. 31, p 818-826). Deformed juvenile rainbow trout, red salmons and chum salmons were reported as caused by deficiency of ascorbic acid, in Annual Meeting of Japan Fisheries Society in 1967. Further, as examples of ascorbic acid deficiencies, there can be mentioned anorexia, slight exophthalmus, hemorrhage at a fin bottom, damage of gill cover and cervical damage in ayu sweet fish; feeding reduction, growth stop, scoliosis, abnormal pigmentation and high mortality rate in juvenile Japanese amberjack; and anorexia, growth reduction, fin hemorrhage and head hemorrhage in Japanese eel. Due to stress caused during culturing, a larger quantity of ascorbic acid is required for cultured fishes such as rainbow trout, red salmon, chum salmon, ayu sweet fish, cherry salmon, greater amberjack, Japanese amberjack, sea bream, common carp and Japanese eel, than the quantity required for wild fishes.

Thus ascorbic acid is an essential supplement for feed. In practice, vitamins including ascorbic acid are incorporated in a feed for juvenile fishes. However, ascorbic acid is an unstable water-soluble vitamin, and is easily decomposed within the feed. Ascorbic acid is extremely unstable especially in fish meal as a protein source, and thus, it's vitamin C titer is greatly reduced by decomposition in a feed predominantly comprised of fish meal, such as feed for rainbow trout.

It is also known that, when a fish meal having ascorbic acid incorporated therein is kneaded and extruded under high-pressure and high-temperature conditions by an extruder in the course of production of a fish-farming feed, ascorbic acid is readily decomposed (for example, see Japanese Unexamined Patent Publication No. H11-056256). In this patent publication, a technique is disclosed wherein an emulsion of water-soluble vitamins is applied to fish-farming feed pellets shaped from fish meal by an extruder. This technique is considered to avoid or minimize decomposition of water-soluble vitamins caused during kneading and extrusion by an extruder.

To remedy the problem of decomposition of vitamin C, an attempt of incorporating vitamin C of a stabilized form, such as salts of L-ascorbate 2-phosphate, in a fish-farming solid feed has been proposed, for example, in U.S. Pat. No. 2,943,785. However, the present inventors have found that, when the fish-farming solid feed is of a globular or columnar shape having a large diameter, or a large amount of vegetable oil and/or animal oil as a nutrient is incorporated in the fish-farming solid feed, vitamin C tends to be decomposed to some extent even if it is of a stabilized form. The degradation of the vitamin C-incorporated fish-farming solid feed proceeds also during storage.

### DISCLOSURE OF THE INVENTION

In view of the foregoing, a primary object of the present invention is to provide a stable fish-farming solid feed having incorporated therein stabilized vitamin C exhibiting high vitamin C titer which is reduced only to a minimum extent during the course of production and storage. Especially even when the stabilized vitamin C-incorporated fish-farming solid feed has a large size and/or has incorporated therein a large amount of vegetable oil and/or animal oil, the fish-farming solid feed exhibits a high vitamin C titer which is reduced only to a minor extent during the course of production and storage.

The present inventors made extensive research and found that partial decomposition of stabilized vitamin C including a salt of L-ascorbate 2-phosphate, as observed when a fish-farming solid feed containing the stabilized vitamin C is of a large size and/or the solid feed contains a large amount of vegetable oil and/or animal oil, occurs predominantly at the step of drying pellets as shaped at a kneading and shaping step using an extruder. Therefore, the inventors attempted to produce fish-farming feed pellets by a process wherein a fish-farming feed material is kneaded and shaped into pellets without incorporation of stabilized vitamin C, and then, after the pellets are dried, stabilized vitamin C is applied to the dried pellets, and found the substantial part of stabilized vitamin C, thus-lately applied, can be retained without any significant deterioration. That is, the thus-applied stabilized vitamin C keeps its high vitamin C titer and exhibits high stability with time in the feed pellets. Based on these findings, the present invention has been completed.

Thus, in accordance with the present invention, there are provided the following fish-farming solid feeds and processes for producing the fish-farming solid feeds.

Fish-Farming Solid Feed

(1) A fish-farming solid feed containing stabilized vitamin C, characterized in that at least 50% by mass of stabilized vitamin C, based on the total weight thereof contained in the solid feed, is present in a surface layer portion of the solid feed, spanning from the surface to a 1 mm depth.

(2) A fish-farming solid feed containing stabilized vitamin C, characterized in that the content of stabilized vitamin C in a surface layer portion spanning from the surface to a 1 mm depth of the solid feed is at least 50 ppm by mass.

(3) The fish-farming solid feed as described in above (1) or (2), wherein the content of stabilized vitamin C in a surface layer portion spanning from the surface to a 1 mm depth of the solid feed is at least 100 ppm by mass.

(4) The fish-farming solid feed as described in any one of above (1) to (3), wherein the total content of stabilized vitamin C in the solid feed is in the range of 25 ppm to 5,000 ppm by mass.

(5) The fish-farming solid feed as described in any one of above (1) to (4), which further contains at least one kind of oil selected from the group consisting of vegetable oils and animal oils.

(6) The fish-farming solid feed as described in any one of above (1) to (4), which further contains 10% to 40% by mass, based on the mass of the solid feed, of a fish oil.

(7) The fish-farming solid feed as described in any one of above (1) to (6), wherein the solid feed has a water content of not larger than 10% by mass.

(8) The fish-farming solid feed as described in any one of above (1) to (7), which has a globular or columnar shape and has a diameter of at least 11 mm.

(9) The fish-farming solid feed as described in any one of above (1) to (8), wherein the stabilized vitamin C is a salt of L-ascorbate 2-phosphate.

(10) The fish-farming solid feed as described in claim 9, wherein the salt of L-ascorbate 2-phosphate is at least one salt selected from the group consisting of magnesium, calcium, sodium and potassium salts of L-ascorbate 2-phosphate, and mixed metal salts thereof.

(11) The fish-farming solid feed as described in any one of above (1) to (10), which is used for feeding a fish or other aquatic animal selected from rainbow trout (Oncorhynchus mykiss), red salmon (sockeye salmon, Oncorhynchus nerka), chum salmon (keta salmon, Oncorhynchus keta), ayu sweet fish (plecoglossus altivelis), Biwa trout, cherry salmon (masu salmon, plecoglossus masou), tuna (Thunnini), white trevally (Pseudocaranxdentex), greater amberjack (Serioladumerili), Japanese amberjack (Seriola quinqueradiata), sea bream (porgy, Sparidac), Japanese seabass (Lateolabrax japonicus), tiger puffer (ocellate puffer, Takifugu rubripes), puffer (Teraodontidac), bastard halibut (paralichthys olivaceus), goldfish, common carp (Cyprinus carpio), Japanese eel (Anguilla japonica), kuruma prawn (Japanese shrimp, Penaeus japonicus) and black tiger prawn (giant tiger prawn, Penaeus monodon).

Process for Producing the Fish-Farming Solid Feed

(12) A process for producing a fish-farming solid feed as described in any one of above (1) to (11), characterized in that a fish farming feed material is kneaded and shaped into a shaped product; the shaped product is dried; and then, the dried shaped product is contacted with stabilized vitamin C having been dissolved, emulsified or dispersed in a liquid.

(13) The process for producing a fish-farming solid as described in above (12), wherein the kneading of the fish-farming feed material is carried out by a heated kneader.

(14) The process for producing a fish-farming solid feed as described in above (12) or (13), wherein the drying of the shaped product is carried out to an extent such that the water content in the shaped product is reduced to 10% by mass or lower.

(15) The process for producing a fish-farming solid feed as described in any one of above (12) to (14), wherein the drying of the shaped product is carried out at a temperature of at least 110° C.

(16) The process for producing a fish-farming solid feed as described in any one of above (12) to (15), wherein the drying of the shaped product is carried out for at least two hours.

(17) The process for producing a fish-farming solid feed as described in any one of above (12) to (16), wherein the stabilized vitamin C is particles having an average particle diameter in the range of 5 μm to 300 μm.

(18) The process for producing a fish-farming solid feed as described in any one of above (12) to (17), wherein the liquid in which stabilized vitamin C has been dispersed comprises at least one kind of oil selected from the group consisting of vegetable oils and animal oils.

(19) The process for producing a fish-farming solid feed as described in any one of above (12) to (17), wherein the liquid in which stabilized vitamin C has been dispersed comprises a fish oil.

(20) The process for producing a fish-farming solid feed as described in any one of above (12) to (19), wherein, after the dried shaped product is contacted with stabilized vitamin C having been dissolved, emulsified or dispersed in the liquid, the resulting shaped product having the liquid deposited thereon is dried.

(21) The process for producing a fish-farming solid feed as described in above (20), wherein the drying of the product having the liquid deposited thereon is carried out at a temperature of not higher than 90° C.

(22) The process for producing a fish-farming solid feed as described in any one of above (12) to (21), wherein the as-produced fish-farming solid feed contains, as measured immediately after the production thereof, at least 60% by mass of stabilized vitamin C based on the amount of stabilized vitamin C incorporated in the shaped product when the shaped product is contacted with the stabilized vitamin C-containing liquid.

### BEST MODE FOR CARRYING OUT THE INVENTION

The kind of stabilized vitamin C used in the present invention is not particularly limited provided that it exhibits higher stability with time in a fish-farming feed than that of natural vitamin C and it is capable of being converted to vitamin C within a living body. The stabilized vitamin C includes, for example, salts of L-ascorbate 2-phosphate, and L-ascorbate 2-glucoside. As preferable examples of the stabilized vitamin C, there can be mentioned magnesium, calcium, sodium and potassium salts of L-ascorbate 2-phosphate, and mixed metal salts thereof such as, for example, a sodium/calcium mixed salt of L-ascorbate 2-phosphate. These stabilized vitamin C may be used either alone or as a combination of at least two thereof.

If non-stabilized vitamin C, for example, natural vitamin C or calcium L-ascorbate is used, a resulting fish-farming solid feed exhibits remarkable degradation due to decomposition of non-stabilized vitamin C occurring during storage as well as at a drying step in the production process.

The stabilized vitamin C-containing fish-farming solid feed of the present invention is characterized in that at least 50% by mass of stabilized vitamin C, based on the total weight thereof contained in the solid feed, is present in a surface layer portion of the solid feed, spanning from the surface to a 1 mm depth; or, in that the content of stabilized vitamin C in a surface layer portion spanning from the surface to a 1 mm depth of the solid feed is at least 50 ppm by mass.

The amount of stabilized vitamin C present in a surface layer portion of the solid feed, spanning from the surface to a 1 mm depth of the sold feed is preferably at least 60% by mass, more preferably at least 65% by mass, based on the total weight thereof contained in the solid feed. The upper limit thereof is not particularly limited, but it is usually about 95% by mass.

The content of stabilized vitamin C in a surface layer portion spanning from the surface to 1 mm depth of the solid feed is preferably at least 100 ppm by mass, more preferably at least 200 ppm by mass and especially preferably at least 250 ppm by mass. The upper limit of the content in the surface layer portion is not particularly limited, but its upper limit is usually about 1.5% by mass.

The total content of stabilized vitamin C in the solid feed is usually in the range of 25 ppm to 5,000 ppm by mass, preferably 100 ppm to 4,000 ppm by mass and more preferably 100 ppm to 2,000 ppm by mass.

The fish-farming solid feed of the present invention containing stabilized vitamin C in a large proportion or content in a surface layer portion thereof is prepared preferably by a process wherein a fish-farming feed material is kneaded and shaped into a shaped product; the shaped product is dried; and then, the dried shaped product is contacted with stabilized vitamin C having been dissolved, emulsified or dispersed in a liquid. If desired, a some amount of vitamin C can be incorporated in the starting fish-farming feed material additionally before it is kneaded and shaped, in addition to the lately applied amount of stabilized vitamin C.

The kneading and shaping of the fish-farming feed material is carried out usually by a heated kneader. The kneader used is not particularly limited and includes, for example, an extruder.

The manner in which the dried shaped product is contacted with stabilized vitamin C having been dissolved, emulsified or dispersed in a liquid is not particularly limited, provided that a desired amount of stabilized vitamin C is incorporated in a desirably distributed fashion in the dried shaped product. Any particular limitation is not imposed to the kind of liquid used, but a liquid containing water is not preferable. If a liquid containing water is used, drying is a gain required and the drying may cause decomposition of applied stabilized vitamin C. It is preferable in view of stability that stabilized vitamin C is applied as an oily slurry which is a dispersion in at least one oil selected from vegetable oils and animal oils. More preferably, stabilized vitamin C is dispersed in fish oil. When an oily slurry is used, stabilized vitamin C has reduced chance of contacting with water, and its decomposition due to hydrolysis can be minimized.

The stabilized vitamin C used is preferably particles having an average particle diameter in the range of 5 μm to 300 μm. The average particle diameter as used herein means a number average particle diameter which is measured by a laser diffraction particle size distribution analyzer (“Micro-track MK-II” available from Nikkisou K.K.). If the particle diameter is too large, the stabilized vitamin C is difficult to be uniformly deposited on the surface of solid feed. In contrast, if the particle diameter is too small, the stabilized vitamin C is difficult to handle.

The liquid in which stabilized vitamin C is dispersed includes vegetable oil and animal oil, which are conventionally added in a fish-farming solid feed. As specific examples of the vegetable oil and animal oil for fish-farming solid feed, there can be mentioned soybean oil and other bean oils, rape-seed oil, corn oil, sesame oil, cotton-seed oil, safflower oil, sunflower oil, peanut oil, rice germ oil, wheat germ oil, camellia (Japanese rose, tsubaki) oil, palm oil, olive oil, jojoba oil, macadamia nut oil, avocado oil, caster-oil, beafsteak plant oil, eucalyptus oil, evening primrose oil, turtle oil, mink oil, lard, beef tallow and fish oil. Of these, fish oil is preferable. Cod oil and sardine oil are especially preferable. These vegetable oils and animal oils may be used either alone or as a mixture of at least two thereof.

If stabilized vitamin C is applied as an emulsion, an emulsifier is used for the preparation thereof. The emulsifier used includes, for example, sorbitan fatty acid esters, glycerin fatty acid esters, organic acid monoglycerides, propylene glycol fatty acid esters, diglycerides, sucrose fatty acid esters, polyglycerin fatty acid esters, recithin, silicone surfactants and alkylene oxide-added surfactants. As specific examples of the emulsifier, there can be mentioned sorbitan monooleate, sorbitan distearate, polyoxyethylene (6 mols) sorbitan monostearate, glycerin monostearate, glycerin monolinolate, an esterified product of citric acid with glycerin monooleate, propylene glycol monostearate, glycerindioleate, glycerindilinolate, diglyceride obtained by ester interchange reaction of rape-seed oil with glycerin, diglyceride obtained by ester interchange reaction of safflower oil with glycerin, diglycerin distearate, diglycerin tristearate, hexaglycerin trioleate, hexaglycerin pentastearate, tetraglycerin condensed ricinolate, polyglycerin condensed ricinoleic acid ester, sucrose tri-, tetra- or penta-stearate, polyoxyethylene (5 mols) cetyl ether, polyoxyethylene (3 mols) nonylphenyl ether, polyoxyethylene (6 mols) stearyl ether, polyoxyethylene (5 mols) hardened castor-oil, polyoxyethylene (15 mols) hardened castor-oil, polyoxyethylene (20 mols) sorbitol tetraoleate, lecithin (e.g., Lecithin DX, Baycis LP-20, available from The Nisshin Oil Mills, Ltd.), dimethylsiloxane-methyl(polyoxyethylene (5 mols)-added) siloxane copolymer, sucrose fatty acid ester, polyglycerin fatty acid ester, lysolecithin, saponin, glycolipid, protein, protein decomposition products (other than gelatin), succrose stearic acid monoester, hexaglycerin oleic acid monoester, decaglycerin stearic acid monoester, enzyme-decomposed lecithin (e.g., Baycis LG-10K, Baycis LP-20E, available from The Nisshin Oil Mills, Ltd.), quillaiae saponin, soybean protein decomposition product, casein sodium, dimethylsiloxane-methyl(polyoxyethylene (60 mols)-added) siloxane copolymer, polyoxyethylene (25 mols) hardened castor-oil and polyoxyethylene (80 mols) hardened castor-oil.

The contact of a dried shaped product of a fish-farming feed material with stabilized vitamin C is conducted in a manner such that usually 25 to 5,000 ppm by mass, preferably 100 to 4,000 ppm by mass and more preferably 100 to 3,000 ppm by mass of stabilized vitamin C, based on the weight of the dried shaped product, is incorporated in the dried shaped product. As examples of the procedure for incorporating the desired amount of stabilized vitamin C in the dried shaped product, there can be mentioned a procedure wherein the dried shaped product is dipped in a liquid having stabilized vitamin C dissolved, emulsified or dispersed therein; a procedure wherein the dried shaped product is coated with a liquid having stabilized vitamin C dissolved, emulsified or dispersed therein; and a procedure wherein a liquid having stabilized vitamin C dissolved, emulsified or dispersed therein is sprayed or atomized on the dried shaped product.

It is essential that a surface layer portion of the solid feed, spanning from the surface to a 1 mm depth, contains either at least 50% by mass of stabilized vitamin C, based on the total weight thereof contained in the solid feed, or, in a content of at least 50 ppm by mass. However, the bond strength of stabilized vitamin C to the solid feed is not particularly limited, provided that a predominant part of the deposited stabilized vitamin C is not separated during transportation from a producing district to a consumption district. An acceptable bonding strength can be obtained by the above-mentioned dipping, coating or spraying procedure of applying a stabilized vitamin C-containing liquid to the solid feed.

The fish-farming solid feed of the present invention preferably contains at least 10% by weight, more preferably 10% to 40% by mass and especially preferably 20% to 30% by mass of vegetable oil and/or animal oil.

To enhance the rate of absorption of vegetable oil and/or animal oil having dispersed therein stabilized vitamin C, the shaped product of fish-farming feed material is preferably dried prior to application of the vegetable oil and/or animal oil to an extent such that the water content in the shaped product is reduced to 10% by mass or lower, more preferably 5% by mass or lower. If the water content in the shaped product is high, the rate of absorption of oil is low, and the efficiency of deposition of stabilized vitamin C is reduced. But, too low water content, e.g., of about 1% by mass or lower, is not preferable because such a low water content is difficult to attain and a substantially long drying time is required with the result of partial decomposition of the active ingredient.

The drying of the shaped product as carried out after kneading and shaping of a fish farming feed material can be carried out usually at a temperature of at least 110° C., preferably in the range of 110° C. to 130° C. for at least 2 hours, preferably in the range of 2 to 4 hours.

After the dried shaped product is contacted with stabilized vitamin C having been dissolved, emulsified or dispersed in a liquid, the shaped product having the liquid deposited thereon is preferably further dried. This further drying is preferably carried out at a temperature of not higher than 90° C., especially preferably in the range of 55° C. to 75° C., so as to avoid decomposition of stabilized vitamin C.

Stabilized vitamin C is retained at a high ratio in the fish-farming solid feed of the present invention. That is, the solid feed contains at least 60%, preferably at least 80% and more preferably at least 90%, of stabilized vitamin C as measured immediately after the production thereof, based on the amount of stabilized vitamin C incorporated in the solid feed.

The shape of the fish-farming solid feed is not particularly limited, and includes, for example, column-shape, globe-shape and square pillar-shape. Especially a column-shaped solid feed called as dry pellet made by using an extruder is widely used. The fish-farming solid feed preferably has a diameter of at least 11 mm, more preferably at least 12 mm and especially preferably at least 15 mm. The upper limit of the diameter is not particularly limited, but is preferably 30 mm, more preferably 25 mm.

The ingredients contained in the fish-farming solid feed of the present invention, other than stabilized vitamin C, are not particularly limited, and can be those which are used in conventional fish-farming solid feeds, such as cereals, pulses, taros and potatoes, oil cake meals, brans, secondary products, animal feeds, vitamins, minerals, and compositions comprised of raw materials.

As specific examples of the cereals, pulses, taros and potatoes, there can be mentioned corn, milo (grain sorghum), wheat, barley, rye, oats, wheat flour, unhulled rice, millet seed, soybean, soybean flour and cassaba.

As specific examples of the oil cake meals, there can be mentioned soybean oil meal, skin-removed soybean oil meal, cotton seed oil meal, rape-seed oil meal, peanut oil meal, linseed oil meal, sesame oil, palm oil meal, safflower oil, sunflower oil, palm nut oil meal and kapok oil meal.

As specific examples of the brans, there can be mentioned rice bran, white sake rice bran, defatted rice bran, wheat bran and barley-mixed bran.

As specific examples of the secondary products, there can be mentioned corn gluten feed, corn gluten meal, starch lees, molasses lees, soy strained lees, beer strained lees, beet pulp, bagasse, bean-curds refuse, malt root and orange juice strained lees.

As specific examples of the animal feed, there can be mentioned fish meal, white fish meal, fish solubles, fish solubles-adsorbed feed, meat meal, meat-and-bone meal, blood meal, feather meal, crab meal, shrimp meal, chrysalis oil meal, skim milk powder, dry whey and animal fat.

As specific examples of the minerals, there can be mentioned sodium chloride, potassium chloride, ferrous citrate, aluminum hydroxide, magnesium carbonate, calcium lactate, magnesium sulfate, sodium dihydrogenphosphate, ferric citrate, ferrous sulfate, potassium iodide and potassium iodate.

Further, the following ingredients can be mentioned. Vegetable oils and fats such as soybean oil, rape-seed oil, corn oil and sesame oil; beer yeast, torula yeast, alfalfa meal, orange-peel, corn-tangle meal, tangle (kelp) meal, wakame sea-mustard meal, freshwater Chlorella, marine Chlorella, cellulose powder and carboxy-cellulose, and vitamin-mixed feeds thereof.

The fish-farming solid feed of the present invention is given to freshwater fishes, marine fishes and other aquatic animals such as crustaceans. As specific examples of the freshwater fishes and marine fishes, there can be mentioned rainbow trout (Oncorhynchus mykiss), red salmon (sockeye salmon, Oncorhynchus nerka), chum salmon (keta salmon, Oncorhynchus keta), ayu sweet fish (plecoglossus altivelis), Biwa trout, cherry salmon (masu salmon, plecoglossus masou), tuna (Thunnini), white trevally (Pseudocaranx dentex), greater amberjack (Seriola dumerili), Japanese amberjack (Seriola quinqueradiata), sea bream (porgy, Sparidac), Japanese seabass (Lateolabrax japonicus), tiger puffer (ocellate puffer, Takifugu rubripes), puffer (Teraodontidac), bastard halibut (paralichthys olivaceus), goldfish, common carp (Cyprinus carpio) and Japanese eel (Anguilla japonica). As specific examples of the crustaceans, there can be mentioned crustaceans, kuruma prawn (Japanese shrimp, Penaeus japonicus), black tiger prawn (giant tiger prawn, Penaeus monodon), river prawn (Macrobrachium spp.), swimming crab (horse crab, Portunus trituberculatus), Japanese spiny lobster (Panulirus japonicus), Japanese taisho prawn, western white shrimp, Chinese prawn (Penaeus chinensis), greasyback shrimp (Metapenaeus ensis), Japanese fan lobster (ahovel-nosed lobster, slipper lobster, Ibacus ciliatus), Japanese lobster (Metanephrops japonicus), Sakura shrimp (Sergialucens), ediblemantis shrimp (Oratosquillaoratoria), prawn, Japanese crayfish (Cambroides japonicus), lobster (Homarus americanus), tanner crab (Chionoecetes opilio), Alaskan king crab (Paralithodes camtschaticus) and helmet crab (Pagurus spp.). The fish-farming solid feed is especially suitable for typical cultured fishes and crustaceans such as rainbow trout (Oncorhynchus mykiss), red salmon (sockeye salmon, Oncorhynchus nerka), chum salmon (keta salmon, Oncorhynchus keta), ayu sweet fish (plecoglossus altivelis), Biwa trout, cherry salmon (masu salmon, plecoglossus masou), tuna (Thunnini), white trevally (Pseudocaranx dentex), greater amberjack (Seriola dumerili), Japanese amberjack (Seriola quinqueradiata), sea bream (porgy, Sparidac), Japanese seabass (Lateolabrax japonicus), tiger puffer (ocellate puffer, Takifugu rubripes), puffer (Teraodontidac), bastard halibut (paralichthys olivaceus), goldfish, common carp (Cyprinus carpio), Japanese eel (Anguilla japonica), kuruma prawn (Japanese shrimp, Penaeus japonicus) and black tiger prawn (giant tiger prawn, Penaeus monodon).

### EXAMPLES

The invention will be described specifically by the following examples that by no means limit the scope of the invention. % in the examples is by mass unless otherwise specified.

In the working examples, the content of a vitamin C derivative (magnesium salt, sodium salt or calcium salt of L-ascorbate 2-phosphate, or calcium salt of L-ascorbic acid) in a solid feed was determined as follows.

A solid feed containing a vitamin C derivative was thoroughly pulverized and placed in a mixed liquid (an aqueous 1% metaphosphoric acid solution/chloroform=1/1 [v/v]). The mixture was shaken to extract the vitamin C derivative. An aqueous phase containing the extracted vitamin C derivative was analyzed by high performance liquid chromatography (HPLC) under the following conditions.
Column: “SHODEX™” J411 available from Showa Denko K.K.
Eluting solution: Mixed liquid of acetonitrile: 0.05M-KH₂PO₄=60:40 (v/v)
Temperature: 40° C.
Flow rate: 1.0 ml/min.
Detection: UV with wavelength of 257 nm

### Example 1

Fish meal, wheat flour, soybean cake meal and fish oil were mixed together at a mass ratio of 60%, 15%, 5% and 20%, respectively, and, to enhance knead ability, water in an amount equal to the fish oil was added to the mixture. Then the mixture was kneaded thoroughly and extruded by an extruder into a columnar extrudate having a diameter of about 14 mm. The columnar extrudate was pelletized and dried at 120° C. for 3 hours until the water content became below 5% to give columnar feed pellets.

Magnesium salt of L-ascorbate 2-phosphate (“Phospitan™ C” available from Showa Denko K.K.; average particle diameter: 15 μm) (hereinafter abbreviated to “APM” when appropriate) was dispersed in fish oil to prepare an oily APM suspension having a concentration of 5,000 ppm by mass. The feed pellets were immersed in the oily APM suspension. After the immersion, the weight of feed pellets was increased by 5%. The 5% increase indicated that the amount of APM taken into the pellets was 250 ppm by mass. APM was extracted from the pellets and its amount was measured. The measured value was 234 ppm by mass.

The APM-containing feed pellets were stored at 40° C. and, when one day, 3 days, 5 days and 10 days elapsed, APM was extracted and its amount was measured. The measured values (APM content in ppm) and retention (%) of APM content are shown in Table 1.

TABLE 1
Retention of APM content

| Number of days elapsed | 1 | 3 | 5 | 10 |
|---|---|---|---|---|
| Content of APM (ppm) | 227 | 225 | 225 | 222 |
| APM Retention (%) | 97 | 96 | 96 | 95 |

### Example 2

A surface layer portion having a thickness of about 1 mm was shaven from the APM-containing feed pellets as made and before storage in Example 1. The surface layer portion was 0.53 g and the remaining core portion was 0.90 g. APM content in each portion was measured. The surface layer portion and the core portion contained APM in amounts of 510 ppm by mass and 75 ppm by mass, respectively.

### Example 3

Solid feed pellets were made by the same procedures as described in Example 1 except that each of sodium salt of L-ascorbate 2-phosphate (hereinafter abbreviated to “APS”) and calcium salt of L-ascorbate 2-phosphate (hereinafter abbreviated to “APC”) was separately used instead of APM. APS used was prepared by the process described in Japanese Unexamined Patent Publication No. H09-077784, and was pulverized into an average particle diameter of 15 μm. APC used was prepared by the process described in Japanese Unexamined Patent Publication No. H06-184173, and was pulverized into an average particle diameter of 15 μm.

The APS- or APC-containing feed pellets were tested for their APS or APC content. The APS content was 230 ppm by mass and the APC content was 225 ppm by mass. These feed pellets were further tested for their APS- or APC-content retention (%) by the same methods as described in Example 1. The results are shown in Table 2 and Table 3, respectively.

TABLE 2
Retention of APS content

| Number of days elapsed | 1 | 3 | 5 | 10 |
|---|---|---|---|---|
| Content of APS (ppm) | 225 | 224 | 222 | 220 |
| APS Retention (%) | 98 | 97 | 97 | 96 |

TABLE 3
Retention of APC content

| Number of days elapsed | 1 | 3 | 5 | 10 |
|---|---|---|---|---|
| Content of APC (ppm) | 220 | 219 | 215 | 215 |
| APC Retention (%) | 98 | 97 | 96 | 96 |

### EXAMPLE 4

An APM-containing aqueous phase was prepared by dissolving 0.5 g of the same APM as used in Example 1, in 49.5 g of water. An oily phase was prepared by dissolving 5 g of hexaglycerin condensed ricinoleic acid ester (“Poem™” PR-300, available from Riken Vitamin K.K., HLB: 1.7) in 50 g of soybean oil at 80° C. While the aqueous phase was gradually added into the oily phase, the two phases were mixed together by a homomixer at 60° C. and 6,000 rpm for 20 minutes to give an APM-containing emulsion.

A feed material mixture was kneaded, extruded and dried by the same procedures as described in Example 1 to give feed pellets. 0.5 g of the above-mentioned APM-containing emulsion was sprayed on 10 g of the feed pellets, and then the resulting feed pellets were air-dried. The content of APM in the as-made feed pellets was 228 ppm by mass.

### Example 5

An aqueous APM solution was prepared by dissolving 0.5 g of the same APM as used in Example 1 in 99.5 g of water. A feed material mixture was kneaded, extruded and dried by the same procedures as described in Example 1 to give feed pellets. 0.5 g of the above-mentioned aqueous APM solution was sprayed on 10 g of the feed pellets, and then the resulting feed pellets were air-dried. The content of APM in the as-made feed pellets was 230 ppm by mass.

### Example 6

The same APM as used in Example 1 was dispersed in fish oil to prepare an oily APM suspension having a concentration of 10%. Using the oily APM suspension, APM-containing feed pellets were made by the same immersion procedures as described in Example 1. The weight increase of feed pellets as measured after the immersion in the oily APM suspension indicated that the amount of APM taken into the pellets was 5,000 ppm by mass. APM was extracted from the feed pellets and its amount was measured. The measured value was 4,900 ppm by mass.

The APM-containing feed pellets were stored at 40° C. and, when one day, 3 days, 5 days and 10 days elapsed, APM was extracted and its amount was measured. The thus-measured retention (%) of APM content was 98%, 96%, 95% and 95% when one day, 3 days, 5 days and 10 days elapsed, respectively.

### Comparative Example 1

Solid feed pellets were made by the same procedures as described in Example 1 except that calcium salt of L-ascorbic acid (hereinafter abbreviated to “ASC”) was used instead of APM. ASC used was prepared by pulverizing the reagent available from Wako Pure Chemical Industries, Ltd., into an average particle diameter of 15 μm.

The ASC-containing feed pellets were tested for their ASC content. The ASC content was 220 ppm by mass. These feed pellets were further tested for their ASC-content retention (%) by the same methods as described in Example 1. The results are shown in Table 4.

TABLE 4
Retention of ASC content

| Number of days elapsed | 1 | 3 | 5 | 10 |
|---|---|---|---|---|
| Content of ASC (ppm) | 180 | 110 | 66 | 11 |
| ASC Retention (%) | 82 | 50 | 30 | 5 |

### Comparative example 2

Solid feed pellets were made by the same procedures as described in Example 1 except that the same APM as used in Example 1 was initially mixed together with fish meal, wheat flour, soybean cake meal and fish oil. The amount of APM added was 250 ppm by mass. The feed material mixture was kneaded, extruded and then dried at 120° C. for 3 hours to give the solid feed pellets.

APM was extracted from the feed pellets and its content was measured. The measured content was 90 ppm by mass. Thus only 36% of the initially added APM remained.

### Example 7

By the same procedures as described in Example 1, solid feed pellets were made except that magnesium salt of L-ascorbate 2-phosphate having an average particle diameter of 500 μm was used instead of APM having an average particle diameter of 15 μm with all other conditions remaining the same. The suspension of particles of magnesium salt of L-ascorbate 2-phosphate in fish oil was not uniform, and deposition of the suspension on the solid feed pellets was not uniform.

### Industrial Applicability

The fish-farming solid feed of the present invention contains stabilized vitamin C at a high proportion or high concentration in the surface layer portion thereof. The vitamin C contained in the solid feed is stable and exhibits high vitamin C titer which is reduced only to a minimum extent during the course of production and storage. Especially even when the stabilized vitamin C-incorporated fish-farming solid feed has a large size, or has incorporated therein a large amount of vegetable oil and/or animal oil, the fish-farming solid feed exhibits a high vitamin C titer which is reduced only to a minor extent during the course of production and storage.

The fish-farming solid feed can be produced by a process wherein a fish farming feed material is kneaded and shaped into a shaped product; the shaped product is dried; and then, the dried shaped product is contacted with stabilized vitamin C having been dissolved, emulsified or dispersed in a liquid. When the dried shaped product is contacted with stabilized vitamin C having been dispersed in vegetable oil and/or animal oil, especially in fish oil, the stability of vitamin C in the solid feed is remarkably enhanced.

The fish-farming solid feed is especially suitable for typical cultured fishes and crustaceans such as rainbow trout, red salmon, chum salmon, ayu sweet fish, Biwa trout, cherry salmon, tuna, white trevally, greater amberjack, Japanese amberjack, sea bream, Japanese seabass, tiger puffer and other puffer, bastard halibut, goldfish, common carp, Japanese eel, kuruma prawn and black tiger prawn.

1. A fish-farming solid feed containing stabilized vitamin C, characterized in that at least 50% by mass of stabilized vitamin C, based on the total weight thereof contained in the solid feed, is present in a surface layer portion of the solid feed, spanning from the surface to a 1 mm depth.

2. A fish-farming solid feed containing stabilized vitamin C, characterized in that the content of stabilized vitamin C in a surface layer portion spanning from the surface to a 1 mm depth of the solid feed is at least 50 ppm by mass.

3. The fish-farming solid feed according to claim 1 or 2, wherein the content of stabilized vitamin C in a surface layer portion spanning from the surface to a 1 mm depth of the solid feed is at least 100 ppm by mass.

4. The fish-farming solid feed according to claim 1 or 2, wherein the total content of stabilized vitamin C in the solid feed is in the range of 25 ppm to 5,000 ppm by mass.

5. The fish-farming solid feed according to claim 1 or 2, which further contains at least one kind of oil selected from the group consisting of vegetable oils and animal oils.

6. The fish-farming solid feed according to claim 1 or 2, which further contains 10% to 40% by mass, based on the mass of the solid feed, of a fish oil.

7. The fish-farming solid feed according to claim 1 or 2, wherein the solid feed has a water content of not larger than 10% by mass.

8. The fish-farming solid feed according to claim 1 or 2, which has a columnar or globular shape and has a diameter of at least 11 mm.

9. The fish-farming solid feed according to claim 1 or 2, wherein the stabilized vitamin C is a salt of L-ascorbate 2-phosphate.

10. The fish-farming solid feed according to claim 9, wherein the salt of L-ascorbate 2-phosphate is at least one salt selected from the group consisting of magnesium, calcium, sodium and potassium salts of L-ascorbate 2-phosphate, and mixed metal salts thereof.

11. The fish-farming solid feed according to claim 1 or 2, which is used for feeding a fish or other aquatic animal selected from rainbow trout (Oncorhynchus mykiss), red salmon (sockeye salmon, Oncorhynchus nerka), chum salmon (keta salmon, Oncorhynchus keta), ayu sweet fish (plecoglossus altivelis), Biwa trout, cherry salmon (masu salmon, plecoglossus masou), tuna (Thunnini), white trevally (Pseudocaranx dentex), greater amberjack (Seriola dumerili), Japanese amberjack (Seriola quinqueradiata), sea bream (porgy, Sparidac), Japanese seabass (Lateolabrax japonicus), tiger puffer (ocellate puffer, Takifugu rubripes), puffer (Teraodontidac), bastard halibut (paralichthys olivaceus), goldfish, common carp (Cyprinus carpio), Japanese eel (Anguilla japonica), kuruma prawn (Japanese shrimp, Penaeus japonicus) and black tiger prawn (giant tiger prawn, Penaeus monodon).

12. A process for producing a fish-farming solid feed as described in claim 1 or 2, characterized in that a fish farming feed material is kneaded and shaped into a shaped product; the shaped product is dried; and then, the dried shaped product is contacted with stabilized vitamin C having been dissolved, emulsified or dispersed in a liquid.

13. The process for producing a fish-farming solid according to claim 12, wherein the kneading of the fish-farming feed material is carried out by a heated kneader.

14. The process for producing a fish-farming solid feed according to claim 12, wherein the drying of the shaped product is carried out to an extent such that the water content in the shaped product is reduced to 10% by mass or lower.

15. The process for producing a fish-farming solid feed according to claim 12, wherein the drying of the shaped product is carried out at a temperature of at least 110° C.

16. The process for producing a fish-farming solid feed according to claim 12, wherein the drying of the shaped product is carried out for at least two hours.

17. The process for producing a fish-farming solid feed according to claim 12, wherein the stabilized vitamin C is particles having an average particle diameter in the range of 5 μm to 300 μm.

18. The process for producing a fish-farming solid feed according to claim 12, wherein the liquid in which stabilized vitamin C has been dispersed comprises at least one kind of oil selected from the group consisting of vegetable oils and animal oils.

19. The process for producing a fish-farming solid feed according to claim 12, wherein the liquid in which stabilized vitamin C has been dispersed comprises a fish oil.

20. The process for producing a fish-farming solid feed according to claim 12, wherein, after the dried shaped product is contacted with stabilized vitamin C having been dissolved, emulsified or dispersed in the liquid, the resulting shaped product having the liquid deposited thereon is dried.

21. The process for producing a fish-farming solid feed according to claim 20, wherein the drying of the product having the liquid deposited thereon is carried out at a temperature of not higher than 90° C.

22. The process for producing a fish-farming solid feed according to claim 12, wherein the as-produced fish-farming solid feed contains, as measured immediately after the production thereof, at least 60% by mass of stabilized vitamin C based on the amount of stabilized vitamin C incorporated in the shaped product when the shaped product is contacted with the stabilized vitamin C-containing liquid.
